(19) United States
(12) Patent Application Publication
(10) Pub. No.: US 2004/0258267 A1
(43) Pub. Date: Dec. 23, 2004

(54) Microphone unit

(76) Inventors: Niels Erik Holm Christensen, Hellerup (DK); Soren Laugesen, Hellerup (DK); Anders Koefed, Hellerup (DK); Steen Madsen, Hellerup (DK); Christian C Burger, Hellerup (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/494,967

(22) PCT Filed: Nov. 4, 2002
(86) PCT No.: PCT/DK02/00733

(30) Foreign Application Priority Data
Nov. 7, 2001 (DK) PA2001 01647

(51) Int. Cl. H04R 11/04; H04R 19/04; H04R 9/08; H04R 21/02

(52) U.S. Cl. 381/355; 381/369; 381/182

(57) ABSTRACT

The invention relates to a microphone unit for use in connection with a communication device, where the microphone unit comprise:—a linear array of two or more microphones (A,B,C,D,);—a signal processing unit which receives the signals from a number of the microphones in the array and which through signal processing provides an output signal with a degree of direction-ality, output means for the signal resulting from the signal processing. According to the invention the microphones (A,B,C,D) are directional microphones of the dipole type mounted with the ports of the dipole pointing in the direction of the linear array thereby enlarging the port spacing of the microphones (A,B,C,D). Low noise levels and good directionality isachieved though this arrangement

### AREA OF THE INVENTION

The invention relates to a microphone unit for use in connection with a further communication device. The microphone unit comprises a number of microphones arranged in a linear array within a housing. In order to achieve directionality of the microphone array, a signal processing unit receives the signals from some or all of the microphones. The signal processor is arranged to process the microphone signals in order to deliver an output signal with a certain directionality. The output signal is served at a further communication device.

Such microphone units are used in connection with a number of different further communication devises such as for example a hearing aid, a headset, a mobile telephone or a personal computer.

The signal from the microphone unit is served at the further communication device in any suitable manner, such as through a wire or wireless by use of a HF transmitter or other wireless transmission paths.

### BACKGROUND OF THE INVENTION

A previously known microphone unit of this type is disclosed in U.S. Pat. No. 6,154, 552. According to this patent the microphone array can be placed inside the temple of an eyeglass. The use of directional microphones is not mentioned. When a high degree of directionality is desired, the array will be sensitive to noise, especially rubbing noise transmitted through the walls of the housing. In U.S. Pat. No. 6,154,552 no special measures are employed to solve this problem.

Microphone arrays are discussed by “Stadler, R. W. & W. M. Rabinowitz, 1993, “On the potential of fixed arrays for hearing aids”, J Acoust Soc. Am. 94. According to the conclusions of this article, the increased noise sensitivity of directional microphones outweighs the theoretical benefits of using directional microphones in the array.

The purpose of the present invention is to make use of the benefits of directional microphones in an endfire directional array, without the negative effects of the increased noise sensitivity.

### SUMMARY OF THE INVENTION

According to the invention a very high degree of directionality is achieved with a microphone unit for use in connection with a communication device, where the microphone unit comprise:

a linear array of two ore more microphones;

a signal processing unit which receives the signals from a number of the microphones in the array and which through signal processing provides an output signal with a degree of directionality,

output means for the signal resulting from the signal processing, where he microphones are directional microphones of the dipole type mounted with the ports of the dipole pointing in the direction of the linear array and wherein one or more of the microphones have a tube extending from the rear and front port, whereby the tube extends in the direction of the linear array thereby enlarging the port spacing of the microphones.

The combination of the directional dipole microphones and the use of the tubes at the ports have a number of benefits:

the variation between the individual microphones of the array is reduced,

it makes alignment of each dipole microphone easier, and this actually,

improves the directionality of the array despite the fact that the directionality of the individual dipole microphone is slightly reduced by the tube mounting,

increases the microphone's sensitivity to the point where an array of dipole microphones is no more noisy than an array of otherwise similar omni-directional microphones.

The microphone unit may be integrated with the signal processing unit in a common housing, or the microphone unit may be a separate unit being connected to the signal processing unit by wire.

The port spacing of the microphone units in the array may wary within a range of 10 to 20 mm, but it has been found that a port spacing of 15 mm is close to the optimal.

The connection between the tubes and microphones may be realized in a number of different ways, e.g. by inserting each microphone into the middle of a suitable tube, and then fastening the microphone to the tube.

Preferably each tube has a circumferential shape and size at a first end, which allows the first end of the tube to embrace the microphone. This ensures a simple and efficient connection between the tubes and corresponding microphones.

In an embodiment of the invention the microphones of the array are suspended by resilient suspensions encircling the tubes at each microphone. Such a resilient suspension helps to dampen unwanted sound transmitted along the walls of the housing and originating from handling the housing of the unit. A symmetrical suspension is achieved by having a suspension at each of the tubes, as each microphone has a tube extending in both the directions of the front port and the rear port.

In a further embodiment the resilient suspension comprise a first member which is shaped to fit tightly around the tube, and a second member arranged to be retained in a housing where the first and second members are interconnected by a plurality of resilient spokes. Through the resilient spokes a very efficient sound isolation between the microphones and the housing is achieved. Further the suspension and the spokes protects the microphones form chocks caused by rough handling of device.

The first and second member of the suspension and the spokes are preferably molded together as one part in a suitable elastomer material.

In a further embodiment the second member of the suspension is shaped to be retained between a first part of the housing and a second part of the housing. Hereby a simple and secure way of retaining the suspension element is obtained.

It is further advantageous if the second member is an annular member, and the first and second part of the housing has an array of furrows corresponding to the second members. Thereby the second member is secured against movement in all directions at all points of its circumference.

Preferably at least one of the housing parts has openings to allow air-borne sounds to enter the tubes and reach the microphones.

### BRIEF DESCRIPTION OF THE DRAWINGS

FIG. 1 is an exploded view of the microphone unit,

FIG. 2 is an enlarged view of a microphone with corresponding tube and suspension.

### DESCRIPTION OF A PREFERRED EMBODIMENT

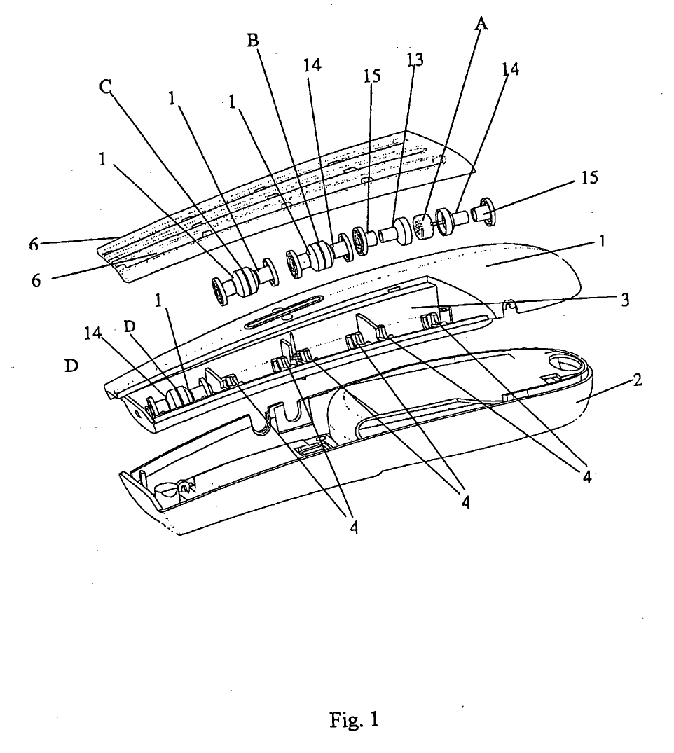

The microphone unit shown in FIG. 1 has a top part 1, and a bottom part 2 where the two parts 1, 2 enclose the electronics of the unit. In the top part 1 a separate compartment 3 is provided, which accommodates the microphones A, B, C and D. The microphone D is shown in the compartment 3 and microphone A is shown isolated from the tubes as explained below.

A cover 6 is provided for the compartment 3, where the cover 6 has a number of openings 6a, which allows the sound from the surroundings to reach the microphones A, B, C, D.

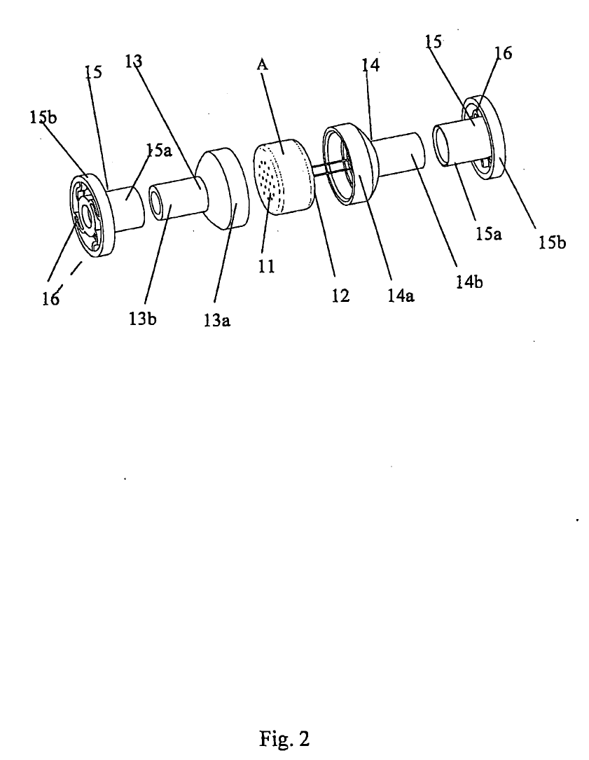

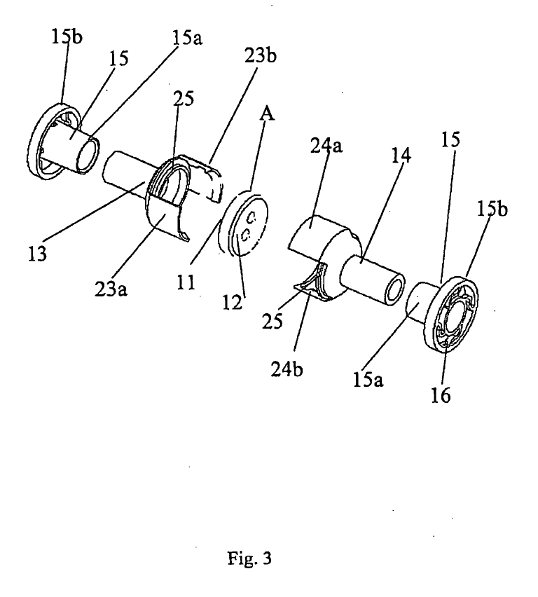

In FIG. 2 the microphone and the tubes are shown in enlarged scale. The microphone A is cylindrical with a first port 11 and a second port 12. A tube 13 is shown adjacent the first port 11 of the microphone A. The tube 13 has a first part 13a with a diameter allowing the tube to embrace the cylindrical microphone A and a second part 13b with a smaller diameter. Adjacent the second port 12 a second tube 14 is shown. This tube 14 is shaped with a large diameter part 14a and a small diameter part 14b as the tube 13. Adjacent the tubes 14 and 13 resilient suspensions 15 are shown. Each suspension 15 has a sleeve 15a shaped to embrace the tube parts 14b and 13b of respective tubes 14 and 13. From the sleeve 15a resilient spokes 16 extend towards a resilient ring 15b surrounding the sleeve 15a.

The large diameter part of the tubes 13a, 14a each forms a small chamber adjacent each side of the microphone A, and in connection with the small diameter parts 13a, 14a a resonator is established. By dimensioning the chamber and the diameter of the small diameter parts of the tubes, the frequency response of the tube-mounted microphone may be influenced. This may be used to improve the natural frequency response of the microphone.

With reference to FIG. 3 a different embodiment of the microphone mounting is shown. Here the tube parts 23a,23b,24a,24b embracing the microphone is shaped differently. The embrasing tube part belonging to tub 13 is composed of two opposed segments 23a, 23b, each comprising ¼ of the circumference. Similarly the embrasing tube part belonging to tube 14 is composed of two opposed segments 24a, 24b, each comprising ¼ of the circumference. Sliding the two tubes 13 and 14 together an enclosure is provided for the microphone A, such that the microphone A is surrounded at all sided by the segments 23a,23b and 24a, 24b. Packing rings 15 may be placed to ensure that the microphone at each of its sound inlet surfaces 11, 12 only receives sound propagated through the tube parts 13 and 14 respectively. The segments 23a,23b,24a,24b each has snap engagement means to ensure that the two tube parts stay together once they have been assembled. The suspension means are essentially the same in this embodiment as in the embodiment depicted in FIG. 2.

In FIG. 1 the microphones B, C and D are shown with the tube parts embracing front and rearward ports of the microphone. Also the resilient suspensions are shown mounted on the tube ends. In the compartment 3 grooves 4 are provided for reception of the ring 15b and similar grooves are provided in the cover part 6. Once the cover 6 is fastened over the compartment 3 the resilient rings 15b encircling each of the tubes are retained in the grooves 4. Thereby the microphones are resiliently suspended and effectively sound isolated from the housing parts 1, 2, 6 and noise generated by handling the housing is not transmitted through the walls of the housing to the microphones.

In the compartment 3 the microphones are all mounted in a line array and with the ports pointing in direction of the line array. The special mounting of the microphones ensures that the microphones are accurately aligned and spaced, and this is most important in order to obtain a high degree of directionality.

If during handling of the device, a foreign substance such as a beverage happens to enter the openings 6a of the cover part 6, this substance is retained in the compartment 3 and does not reach the electronic parts of the unit. Further the construction allows easy access to the microphones, so that defect microphone may easily be replaced. The microphones are connected to the electronic parts of the device through thin wires (not shown) and a small hole (not shown) is arranged in the compartment such that the wires may be connected to the electronics of the device.

1. A microphone unit for use in connection with a communication device, where the microphone unit comprises:
a linear array of two or more microphones (A, B, C, D);
a signal processing unit which receives the signals from a number of the microphones in the array and which through signal processing provides an output signal with a degree of directionality,
output means for the signal resulting from the signal processing,
wherein the microphones (A, B, C, D) are directional microphones of the dipole type mounted with the ports of the dipole pointing in the direction of the linear array and wherein one or more of the microphones have a tube (13, 14) extending from the rear and front port, whereby the tube (13, 14) extends in the direction of the linear array thereby enlarging the port spacing of the microphones (A, B, C, D).

2. A microphone unit as claimed in claim 1, wherein each tube (13, 14) at a first end (13a, 14a) has a circumferential shape and size, which allows the first end of the tube to embrace the microphone.

3. A microphone unit according to claim 1, wherein the microphones (A, B, C, D) of the array are suspended by resilient suspensions (15, 16) encircling the tubes (13, 14) at each microphone (A, B, C, D).

4. A microphone unit according to claim 2, wherein the resilient suspension (15) comprise a first member (15a) which is shaped to fit tightly around the tube (13, 14), and a second member (15b) arranged to be retained in the housing (1, 6) where the first and second members (15a, 15b) are interconnected by a plurality of resilient spokes (16).

5. A microphone unit as claimed in claim 4, wherein the second member (15b) is shaped to be retained between a first part of the housing (1) and a second part of the housing (6).

6. A microphone unit as claimed in claim 5, wherein the second member (15b) is an annular member, and wherein the first and second part of the housing (1,6) has an array of furrows (4) corresponding to the second members (15b).

7. A microphone unit as claimed in claim 1, wherein at least one of the housing parts has openings (6a) to allow air-borne sounds to enter the tubes (13, 14) and reach the microphones (A, B, C,D).
